(19) United States
(12) Patent Application Publication
(10) Pub. No.: US 2008/0078875 A1
(43) Pub. Date: Apr. 3, 2008

(54) Method for Reducing Motion Sickness During Parabolic Flight

(75) Inventors: Peter H. Diamandis, Santa Monica, CA (US); Angel Panlasigui, Santa Monica, CA (US)

Correspondence Address: JEFFREY A. TRAVIS;c/o Plager Law Offices, P.C., 16152 Beach Blvd., Suite 207, Huntington Beach, CA, 92647, US

(73) Assignee: ZERO GRAVITY CORPORATION, Ravenswood, FL (US)

(21) Appl. No.: 11/533,746

(22) Filed: Sep. 20, 2006

(51) Int. Cl. B64D 45/00; B64D 11/00

(52) U.S. Cl. 244/118.5; 244/1 R

(57) ABSTRACT

A method for reducing motion sickness of passengers during parabolic flight comprising the combination of known and novel methods for flying parabolic arcs and coordinating passenger behavior during parabolic flight including graduating from heavier to lighter gravity environments; flying one or more sets of parabolic arcs for each gravity environment; flying on a path generally parallel to the surface of the earth after each set of parabolic arcs; flying no more than twenty parabolic arcs; or having passengers lying supine when entering or exiting each parabolic maneuver.

### BACKGROUND OF THE INVENTION

1. Field of the Invention

The present invention relates to a method for reducing motion sickness. More particularly, the present invention comprises a method for reducing motion sickness during parabolic flights.

2. Description of Related Prior Art

There are a host of methods and devices for reducing motion sickness during different types of vehicular motion. These devices are comprised of motion sickness pills, herbal remedies, and other devices primarily used for passengers in automobiles, airplanes, and on boats. Further, various techniques have been tried individually but cannot account for the varied physiological makeup of multiple persons.

The force levels experienced by the human body during parabolic flight are significantly greater and for a longer duration than those experienced in an automobile, a normal airplane flight, or even that of a roller coaster. Because of the increased forces that act in conflict with the normal balancing processes coordinated by the brain, ears and eyes, motion sickness during parabolic flights can be as much as 60%-80% of a plane's passengers according to NASA flight instructors. (See, Tariq Malik, Science.com, Sep. 21, 2004, The Balance Factor: Can you handle Zero G?) Comparatively, high-quality military flight simulators are reported to elicit symptoms in 40% to 70% of pilots in training. Gillingham K K, Previc F H., Spatial orientation in flight. In: DeHart R L, ed. Fundamentals of aerospace medicine. 2nd ed. Baltimore: Lippincott Williams & Wilkins, 1996:309-97.

To create a weightless environment specially trained pilots fly parabolic arcs at approximately 24,000 and 32,000 feet. The maneuver is somewhat like a roller coaster where the plane is initially pulled up to approximately 45 degrees ‘nose high.’ Next the plane is ‘pushed over’ the top to reach the zero-gravity segment of the parabolas. For the next 25-30 seconds everything in the plane is weightless. At approximately 30 degrees ‘nose low’ a gentle pull-out is started which allows the passengers to stabilize on the aircraft floor. Finally, the g-force is increased smoothly to about 1.8 g's until the aircraft reaches level flight at an altitude of 24,000 feet. This maneuver is then repeated.

The weightlessness experienced by the passengers inside the airplane is actually equivalent to the type of “free fall” you experience when sky diving. In this case however, the body of the aircraft surrounds you and protects you from the on-rushing wind. At the end of the free fall period, the aircraft also scoops you up and carries you back up to the top of the arc to begin the free fall process again.

Currently, there are very few providers of weightless or, ‘microgravity’, flights. NASA has been the largest provider of parabolic flights and has flown over 150,000 of them over the past 50 years for training pilots, astronauts, and for science experiments for the public and private sector. Traditionally NASA flies upwards of 30 or more parabolas per flight, giving rise to the name ‘vomit comets’ for these flights, thereby making them less than appealing to potential customers. (See, www.nasa.gov/audience/foreducators/postsecondary/features/F_Ups_and_Downs.html,www.nasa.gov/missions/research/kc135.html, and www.nasa.gov/audience/forstudents/5-8/features/F_Alissa_Kuseske.html) Other providers of weightless flights include the French government,(www.novespace.com) the Department of Defense, and the Russian Space Program who perform parabolic flights similar to NASA.

The problem with overcoming motion sickness is that there is no one procedure that is effective for every person. See, Yolton, Citek, Coffey, and Laukkanen, Etiology and Management of Motion Sickness: A review of Optometric Considerations, http://www.opt.pacifu.edu/ce/catalog/13459-GO/Motionsick.html. Further, most attempts at reducing motion sickness utilize only one or two methods for counteracting motion sickness rather than a multidisciplinary one that incorporates a methodical multi-tiered approach.

Because parabolic flights have become privatized and mainstream, passengers are no longer seasoned veterans experienced to the fluctuations in motion that produce motion sickness. Also, it is impossible to treat each person individually through a full physical or other medical examination to assess a particular medical regimen to reduce motion sickness. Because there is currently no effective, prescribed method for reducing motion sickness during parabolic flights that simulate a weightless environment that take into account the physiological variety in passengers, what is needed is a consistent, effective, universal, and multidisciplinary method for treating the physical and psychological effects of motion sickness brought on by parabolic flights.

### SUMMARY OF THE INVENTION

It is therefore one object of the present invention to reduce motion sickness for passengers on a parabolic flight through a multidisciplinary method that incorporates multiple known and novel techniques including: graduating from heavier to lighter gravity environments; flying one or more sets of parabolic arcs for each gravity environment; flying on a path generally parallel to the surface of the earth after each set of parabolic arcs; flying no more than twenty parabolic arcs; or having passengers lying supine when entering or exiting each parabolic maneuver.

### BRIEF DESCRIPTION OF THE DRAWINGS

FIG. 1 is a table showing the altitude and flight path of a plane during a 65 second interval and where weightless occurs during one parabolic flight maneuver.

FIG. 2 is a chart showing a percentage of motion sickness during normal parabolic flight without using the method of the present invention and a percentage of motion sickness when using the present invention.

FIG. 3 is a bulleted outline of a preferred flight plan showing the type and number of arcs flown during a graduated reduced gravity flight.

FIG. 4 is a cross-sectional cutout view of passengers lying on their backs in a supine position in the cargo area of a fuselage of a plane converted for parabolic flight just before pullout of a parabolic arc trajectory.

### DETAILED DESCRIPTION OF THE DRAWINGS AND PREFERRED EMBODIMENTS

A complete understanding of this invention can be gained through reference to the drawings in conjunction with a thorough review of the disclosure herein.

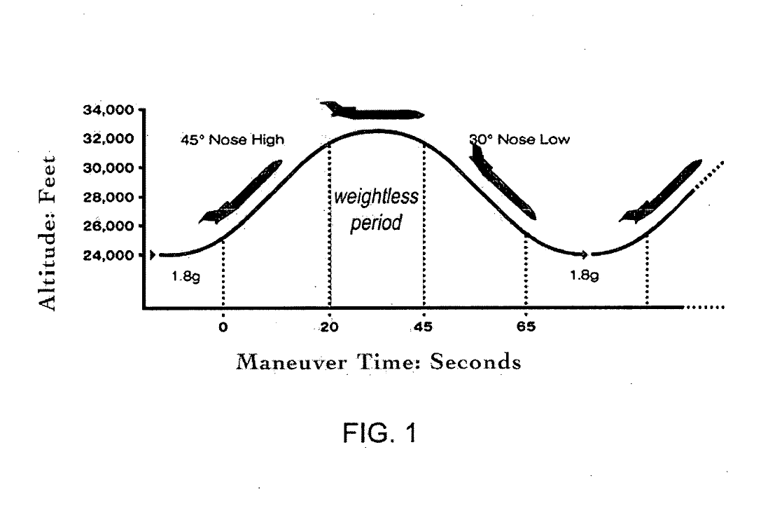

A plane flight can simulate zero gravity by flying a parabolic arc. Typically, as is shown in FIG. 1, a plane will begin a ‘nose high’ maneuver of approximately 45° at about 24,000 feet. However, the exact altitude of the start of parabolic flight can vary but is largely determined by general and specific flight rules set forth by the Federal Aviation Administration in the Code of Federal Regulations. (See, FAR §91) The nose high incline will continue until an upper altitude of about 34,000 feet is reached. During this climb, passengers experience an increased gravitational pull at which point a ‘nose low’ maneuver of 45° will cause the plane to descend back to approximately 24,000 feet. For approximately 30 seconds, passengers will experience weightlessness.

Motion sickness is not caused by any one stimuli but can be caused by several. (E.g., visual stimuli, motion, simulations, and etc) By the same token, no one method for reducing motion sickness will work for every person. Motion sickness can be caused by the psychological threat of sickness, by the actual physical conflict created on the sense organs during certain parabolic maneuvers, or by the varied motion created by the plane and flight path. Therefore, a multi-tiered approach, such as that of the present invention is necessary to overcome the very real physical and psychological effects of flying 10 mile arcs several miles above the earth.

The exact multidisciplinary method for consistently reducing motion sickness during parabolic flights was discovered through a refinement of combinations of novel and tried techniques. The elements of the several techniques utilized were:
Prescribing pre-flight meals
Changing the total number of parabolic flights
Graduating the gravitational effect on passengers
Flying discrete sets of parabolic flights
Leveling the plane after completing a set of parabolic arcs
Implementing passenger focusing techniques
Prescribing Medications and specific meals before flight

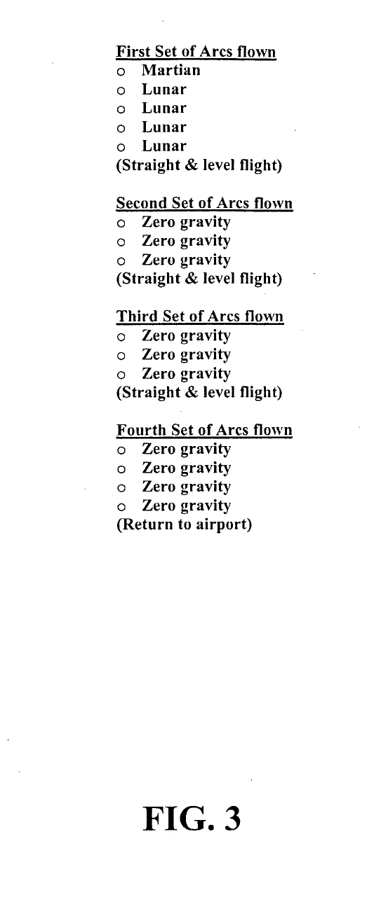

Initially, and similar to flights taken by NASA and other public and private entities, about 30-40 parabolic arcs were flown per flight. However, it was slowly discovered that approximately 20 parabolic flight maneuvers was the upper limit for passengers not experienced at flying these types of flight maneuvers. However, reducing the amount of parabolic flights reduces the onset of motion sickness up to 35%. A preferred range of total number of parabolic arcs flown is between 15 and 20. In a preferred embodiment, the number of parabolas for ZEROG public flights is limited to 15. (See FIG. 3) Fifteen is a number which has been found that most everyone can handle with an upper limit being twenty and achieving an acceptable level of motion sickness for passengers.

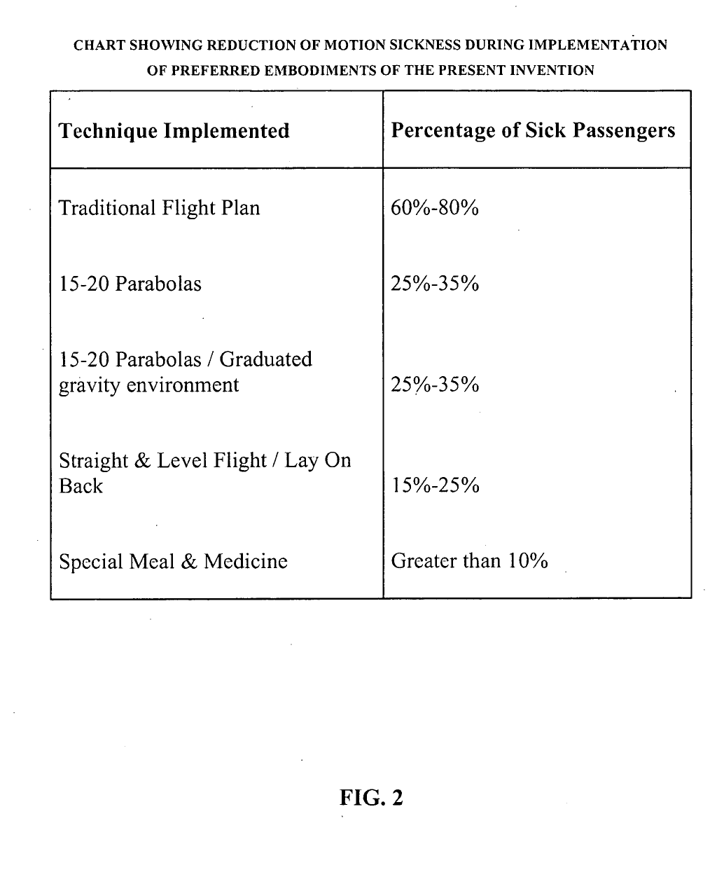

Another exemplary ingredient for the preferred method of reducing motion sickness is for a passenger to generally acclimate themselves to zero/micro gravity. This can be done by varying the degree of entry into a parabolic arc to account for varying gravities found on different planetary bodies. (E.g., Mars, the moon, and etc.) Although the technique for performing a simulated weight of a planetary body during parabolic flight is known, its use either singularly or in combination with other novel or known techniques for reducing motion sickness, has not. A preferred technique for reducing motion sickness during parabolic flight is to graduate the level of weightlessness. Using the preferred method of the present invention, this technique comprises entering an arc that simulates a gravity less then the earth but greater than zero gravity, (e.g., Martian) to a gravity less than the Martian, (e.g., lunar) and finally to a zero gravity simulation. It is this technique that, as is shown in FIG. 2, also reduces motion sickness by up to 35% when used singularly or in combination with a reduction in total parabolas flown. For passengers who are more inclined to motion sickness the graduation into various weightless environments can be modified to intervening degrees of weightlessness although the percentage of those experiencing and not experiencing motion sickness is nominal.

FIG. 3 shows a preferred graduated parabolic arc flight plan. A first set of parabolic arcs traverses one arc simulating Martian gravity with a second, third, fourth, and fifth arc simulating lunar gravity. In this way, passengers become slowly acclimated to a reduced gravity environment before they enter a zero gravity environment during the remaining sets of arcs. Moreover, varying the total number of Martian or lunar simulations is also possible and those who are familiar with flying parabolic arcs will readily see the various combinations that can be utilized.

In addition to graduating the types of parabolic arcs traversed by a plane from a heavier to lighter environment, the total number of parabolic arcs flown for any one flight can be segregated into several sets. For example, a first set of arcs can simulate the Martian weight, a second set can simulate lunar weight, and a third set can simulate zero gravity whereby the aggregate number of arc flown totals a preferred number of no more than 20. Of course, any of the several elements for reducing motion sickness can be incorporated into the present invention which can therefore increase the total aggregate number of arcs or sets of arcs flown thereby not limiting the total aggregate number to 20.

A result of flying discrete sets of parabolic flights instead of a constant succession of 20 or more parabolas is a slower adaptation to the motion created by a plane. Alone, and in combination with a reduced number of parabolas and by leveling the flight path as described below, (See, FIG. 2) an adaptation element created by the discrete flight paths allows each passenger to slowly orient themselves to the variety of motions created by the plane. Of all the embodiments, having passengers lie in the supine position or, flying a straight and level flight between arcs has proven to have the greatest reduction in motion sickness at the level. Results have yielded (FIG. 2) a reduction in motion sickness from 35%-45%.

In addition to limiting the total number of parabolic arcs, graduating the type of arc, and flying the arc in discrete sets, an exemplary embodiment that can be added to the preferred method is to level off the flight after a selected number of parabolic flights flown thereby allowing passengers to recover their balance before entering more parabolic arcs. This method, and in combination with lying supine or during a graduated flight (not shown) has also reduced motion sickness by a significant degree.

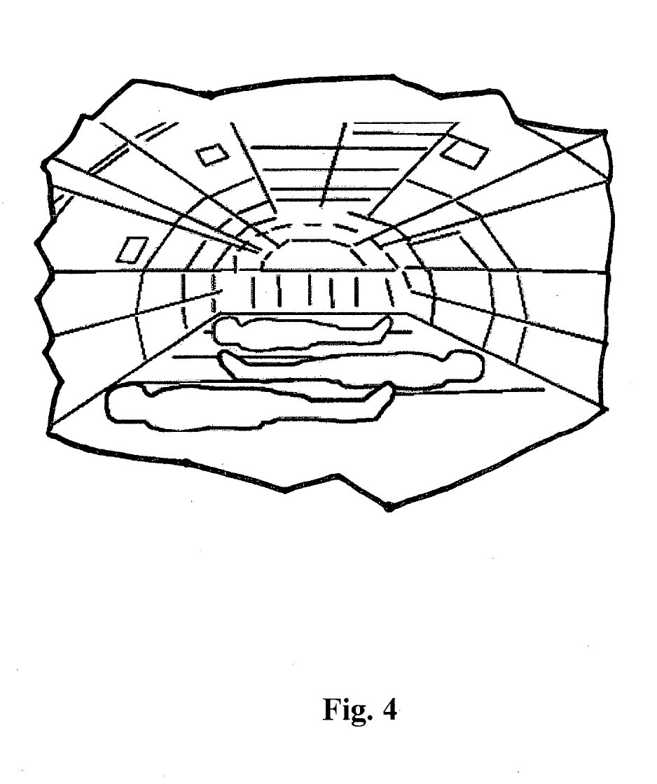

Another exemplary embodiment for a multidisciplinary approach to reducing motion sickness is to have passengers change their posture and focusing techniques. Specifically, assuming a supine position can reduce sickness from 27.5% to 5%. FIG. 4 shows passengers lying supine in a plane cargo area just before the 1.8 g pullout. Additionally, another method that can be used in combination with a supine position for reducing motion sickness is to have passengers remain focused on a fixed point while lying in a supine position during the 1.8 g pullout.

In addition to the disclosed embodiments of the present invention, passengers who follow a prescribed pre-flight meal also experience reduced motion sickness. Preferred meals before flight are meals low in proteins or dairy products.

Another cause of motion sickness that precedes and often outlasts its actual physiological effects are psychological anxieties about experiencing events that can cause motion sickness. See, supra, Yolton, et al., p. 23. To counteract the psychological anxiety that is an “integral part of motion distress” that precedes motion sickness of the type experienced on a parabolic flight, a psychological counteractive such as that of announcing a method for effectively treating motion sickness before passengers begin their flight, can be one of several primary components for a multidisciplinary approach for treating motion sickness.

Pre-flight presentations, where passengers are educated on the reasons for motion sickness and assuring them preparations have been made to ensure that the chances of motion sickness, although not completely eliminated, have been greatly diminished, can go a long way to relieving those anxious about flight. Typical presentations show graphical representations of known “conflict” theory of balance that occurs during motion sickness and how that conflict theory is counteracted by a variety of methods available to each passenger. In this embodiment, passengers are advised of medication, lights meals, limited number of parabolas, an adapted and graduated lead-in to microgravity, and a positive psychological reinforcement statement. Other presentation embodiments can include arrangements of the various methods described in this specification in any number of arrangements. Further, although documented pre-flight presentations are preferred, verbal presentations can also be effective when conducted according to the objects of the present invention.

Using a combination of the above described methods has yielded significant results. The chart of FIG. 2 outlines the percentage of sick passengers using a preferred method of the present invention for reducing motion sickness during parabolic flight. Sickness is qualitatively and quantitatively based on visual evidence and verbal statements of motion sickness from passengers and from flight directors and pilots. Flying a standard NASA flight plan without the use of the techniques of the present invention increases the chance of motion sickness by 25% or more.

Individual embodiments and combinations thereof of the several methods have consistently yielded similar results as has the addition of including psychological precursors to flights such as methodology assurances of non-sickness and pre-flight operations to assuage passenger fears.

### CONCLUSION, RAMIFICATIONS, AND SCOPE

While the above description contains various preferred, exemplary, and other specific embodiments, these should not be construed as limitations on the scope of the invention, but as exemplifications of the presently preferred embodiments thereof. Many other ramifications and variations are possible within the teaching of the invention.

Thus the scope of the invention should be determined by the appended claims and their legal equivalents, and not solely by the examples given.

We claim:

1. A method for reducing motion sickness of passengers during parabolic flight comprising:
graduating from heavier to lighter gravity environments; and
flying one or more sets of parabolic arcs for each gravity environment.

2. The method of claim 1 further comprising the step of flying no more than twenty parabolic arcs.

3. The method of claim 1 further comprising the step of flying on a path generally parallel to the surface of the earth after each set of parabolic arcs.

4. The method of claim 1 further comprising the step of having passengers lying supine when entering or exiting each parabolic maneuver.

5. The method of claim 1 wherein the graduation of weightless environments comprises traversing a first set of parabolic arcs simulating Martian gravity, traversing a second set of parabolic arcs simulating lunar gravity, and traversing a third set of parabolic arcs simulating zero gravity.

6. The method of claim 1 wherein graduating the weightless environments comprises traversing a first set of parabolic arcs simulating Martian gravity and lunar gravity, and a third set simulating zero gravity.

7. The method of claim 1 wherein the total number of parabolic arcs traversed by the plane is fifteen.

8. The method of claim 1 further comprising the step of prescribing a pre-flight meal low in proteins or dairy products.

9. The method of claim 1 further comprising the steps of passengers assuming a supine position during flight and focusing on a fixed point when exiting each parabolic arc.

10. A method for reducing motion sickness of passengers during parabolic flight comprising: flying no more than twenty parabolic arcs.

11. The method according to claim 10 further comprising flying on a path generally parallel to the surface of the earth after each set of parabolic arcs.

12. The method according to claim 10 further comprising passengers laying supine when exiting each parabolic arc.

13. The method according to claim 10 further comprising traversing a first set of parabolic arcs simulating Martian gravity, traversing a second set of parabolic arcs simulating lunar gravity, and traversing a third set of parabolic arcs simulating zero gravity.

14. A method for reducing motion sickness of passengers during parabolic flight comprising passengers lying supine when exiting each parabolic arc.

15. A method for reducing motion sickness of passengers during parabolic flight comprising: flying one or more sets of parabolic arcs for each gravity environment.

16. A method for reducing motion sickness of passengers during parabolic flight comprising flying on a path generally parallel to the surface of the earth after each set of parabolic arcs.

17. The method in claim 15 wherein the total number of parabolic arcs comprises no more than twenty.

18. The method of claim 16 further comprising passengers lying supine when entering or exiting each parabolic arc.
